(19) United States
(12) Patent Application Publication
(10) Pub. No.: US 2026/0074625 A1
(43) Pub. Date: Mar. 12, 2026

(54) SINGLE PHASE CONTROLLED 3-PHASE 4 WIRE POWER CONVERTER

(71) Applicant: Westinghouse Electric Company LLC, Cranberry Township, PA (US)

(72) Inventors: Scott M. Sweat, Pittsburgh, PA (US); Ibrahim B. Ezelarab, Mars, PA (US)

(73) Assignee: Westinghouse Electric Company LLC, Cranberry Township, PA (US)

(21) Appl. No.: 18/827,707

(22) Filed: Sep. 7, 2024

(51) Int. Cl. H02M 5/458; H02M 1/00; H02M 1/12; H02P 27/06

(52) U.S. Cl. CPC H02M 5/4585; H02M 1/007; H02M 1/126; H02P 27/06

(57) ABSTRACT

A three-phase power converter comprises a converter circuit to couple to the alternator: a first voltage at a first amplitude and a first phase, a second voltage at a second amplitude and a second phase, and a third voltage at a third amplitude and a third phase. The converter circuit comprises a combiner circuit comprising alternator gate drivers and grid gate drivers. The power converter comprising a high voltage DC link and a control circuit to: receive the first, second, and third voltages at the first, second, and third amplitudes and phases from the alternator; control the plurality of alternator gate drivers and the plurality of grid gate drivers to combine the first, second, and third voltages at the first, second, and third amplitudes and phases; and output an output voltage at an amplitude and a phase based on the combination of the first, second, and third voltages.

### GOVERNMENT CONTRACT

This invention was made with government support under DE-NE0009050 awarded by the U.S. Department of Energy. The government has certain rights to the invention.

### FIELD

This disclosure relates generally to the field of and more particularly relates to a three-phase power converter.

### SUMMARY

In part, in one aspect, the disclosure relates to a three-phase power converter. The three-phase power converter comprising a converter circuit coupleable to an alternator. The converter circuit to couple to the alternator: a first voltage at a first amplitude and a first phase; a second voltage at a second amplitude and a second phase; and a third voltage at a third amplitude and a third phase. The converter circuit comprising a combiner circuit, the combiner circuit comprising: a plurality of alternator gate drivers; and a plurality of grid gate drivers. The three-phase power converter comprising a high voltage DC link coupled to the plurality of alternator gate drivers and the plurality of grid gate drivers and a control circuit to: receive the first, second, and third voltages at the first, second, and third amplitudes and phases from the alternator; control the plurality of alternator gate drivers and the plurality of grid gate drivers to combine the first, second, and third voltages at the first, second, and third amplitudes and phases; and output an output voltage at an amplitude and a phase based on the combination of the first, second, and third voltages.

In part, in one aspect, the disclosure relates to a three-phase power converter. The three-phase power converter comprising a converter circuit coupleable to an alternator. The converter circuit to couple to the alternator: a first voltage at a first amplitude and a first phase, a second voltage at a second amplitude and a second phase; and a third voltage at a third amplitude and a third phase. The converter circuit comprising a combiner circuit, the combiner circuit comprising: a plurality of alternator gate drivers; and a plurality of grid gate drivers. The three-phase power converter comprising a high voltage DC link coupled to the plurality of alternator gate drivers and the plurality of a grid gate drivers; and a control circuit to: receive a first input voltage at a first amplitude and a first phase, wherein the first input voltage is an alternating current (AC) voltage; control the plurality of alternator gate drivers and the plurality of grid gate drivers to the combiner circuit to form the first, second and third voltages at the first, second and third amplitudes and phases based on the first input voltage at the first amplitude and the first phase, and output the first, second, and third voltages at the first, second and third phases of the alternator.

In part, in one aspect, the disclosure relates to a three-phase power converter. The three-phase power converter comprising: a first pair of converters coupled to an alternator; a second pair of converters coupled to the alternator; and a third pair of converters coupled to the alternator. Each pair of converters is to control a phase of three phase power based on an input voltage at a phase and an amplitude received at each converter of the pairs of converters.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation.

In one aspect, the present disclosure relates to a three-phase power converter system designed to interface with an alternator. The system effectively captures and utilizes various phases of power generated by an alternator and optimizes these for grid distribution or other uses, while also taking measures to reduce emission losses and improve efficiency. The converter circuit contains a combiner circuit, which includes sets of alternator and grid gate drivers, coupled to a high voltage DC link. The system is controlled by a circuit that receives voltages at different phases and amplitudes, which it then combines and outputs as a voltage suitable for use by, or sale to, a power grid.

Various aspects of the three-phase power converter system include conversion of three distinct voltages from the alternator to a direct current (DC) voltage, followed by conversion to an output voltage at a desired amplitude and phase. Rectification of voltages to DC is followed by the application to the high voltage DC link. Gate drivers are controlled to convert DC voltage into a two-phase AC voltage for grid output. Integration of filters such as an alternator in-line choke filter and a grid-side high-frequency filter reduces interference in the conversion process. The control circuit is configured to receive input voltages and control the gate drivers based on these input voltages to produce desired output voltages. The control circuit is configured to adjust input voltages for alternator needs.

Other aspects of the three-phase power converter include controlling the system's reception and output of voltages. Other aspects include, converting the input voltage to a DC and then inverting this DC to the output voltages at different phases and amplitudes. Converter pairs are arranged to control the phases of power based on the input voltage while the master control circuit role manages these controls. The converters receive input voltage from a grid and the subsequent conversion.

These and other features of the applicant's teachings are set forth herein.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 is a converter pair, according to an aspect of the present disclosure.

FIG. 2 is a three-phase converter, according to an aspect of the present disclosure.

FIG. 3A-3B illustrates a system to control three-phase power, according to an aspect of the present disclosure.

FIG. 4 illustrates the connection between the motor and the three-phase power converter module, according to an aspect of the present disclosure.

FIG. 5 illustrates a more detailed view of the windings of the motor, according to an aspect of the present disclosure.

FIG. 6A-6B is a system level diagram of the converter module, according to an aspect of the present disclosure.

FIG. 7A-7C is a circuit diagram of a converter circuit, according to an aspect of this disclosure.

### DETAILED DESCRIPTION

This disclosure is directed to a power electronic system (PES) comprising separate converter assemblies that convert the output of the high-speed alternator to the voltage and frequency needed at a grid. The converter assemblies are also directed to converting microgrid voltage and frequency to the voltage and frequency needed by an alternator, such as an alternator to start up the eVinci™ Microreactor by Westinghouse Electric Company LLC. The eVinci™ Microreactor is a reduced size transportable modular nuclear reactor for decentralized remote applications. The PES also includes a battery system to support the load follow functionality. The PES assembly may contain various microcontrollers, filtering units, and a cooling system to remove heat from the power electronics during the conversion process.

In general, the power electronics system is made up of six individual back-to-back converters. Two converters are stacked as a set/pair and supply one phase of three phase power. In general, for three phase power, there are 3 phases total with a 4-wire output where each phase has an individual wire and neutral has a wire. Each phase may be independently controlled by a converter pair to accommodate phase imbalances and mitigate single phase faults. This construction of converter pairs may allow for lower voltage converters to be stacked and isolated from each other without any external transformers. The close coupling of the converter pairs may keep the direct current (DC) link voltages close to one another.

In general, the PES assembly may allow for either delta or wye output configurations for the three-phase power. For example, the controller design allows for multiple eVinci™ Microreactors to be operated in parallel with any one unit operating in “grid forming” mode and the rest operating in “grid following” mode. Any unit can be switched to “grid forming” depending on the needs of the system.

In general, this disclosure eliminates the need for an additional output transformer to convert three wire standard output to four wire output. Also, the ability for the PES to control voltage and reactive power in each phase individually eliminates the need for any additional volt-ampere reactive (VAR) compensation. Standard off-the-shelf products would require additional components to perform the same functions already required by the current system. Additionally, the PES can be optimized with various features that can be activated or deactivated based on individual customer needs.

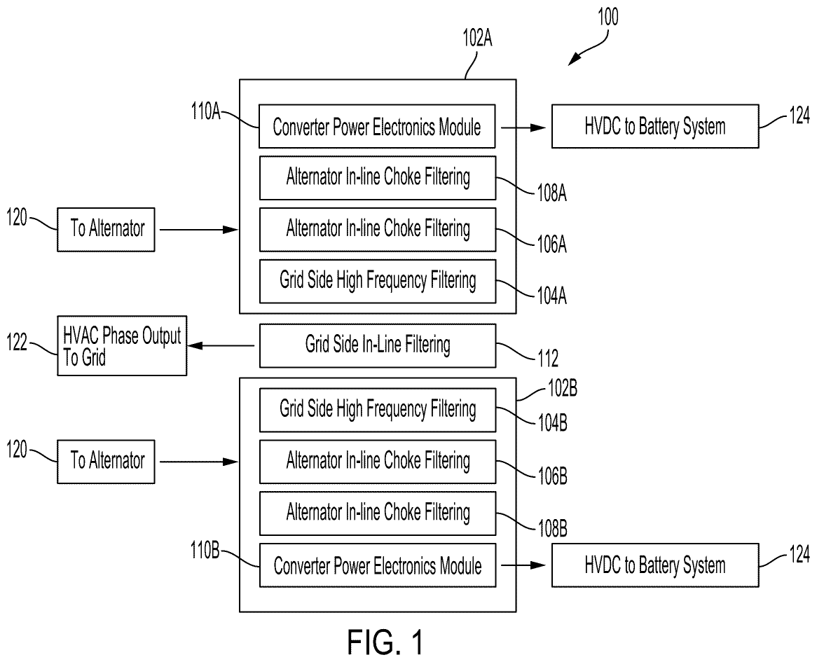

With reference now to the figures, FIG. 1 is a converter pair 100, according to an aspect of the present disclosure. The converter pair 100 comprises a first converter circuit 102A and a second converter circuit 102B. The first converter circuit 102A is coupled to the second converter circuit 102B by a grid side in line filter 112. The grid side in line filter 112 couples the first converter circuit to the second converter circuit. The grid side in line filter 112 is configured to filter the output from the converter pair 100 to the grid 122 or to filter the input from the grid 122 to the converter pair 100.

The first converter circuit 102A may comprise a converter power electronics module 110A, a first alternator in-line filter 106A, a second alternator in-line filter 108A, and a grid side filter 104A. The power electronics module 110A may be configured to control the first converter circuit 102A. The first 106A and second 108A in-line filter may be configured to filter the input to and the output from the motor by blocking high frequency signals. The grid side filter 104A may filter the input from the grid and the output from the first converter circuit 102A to the grid and block high frequency signals.

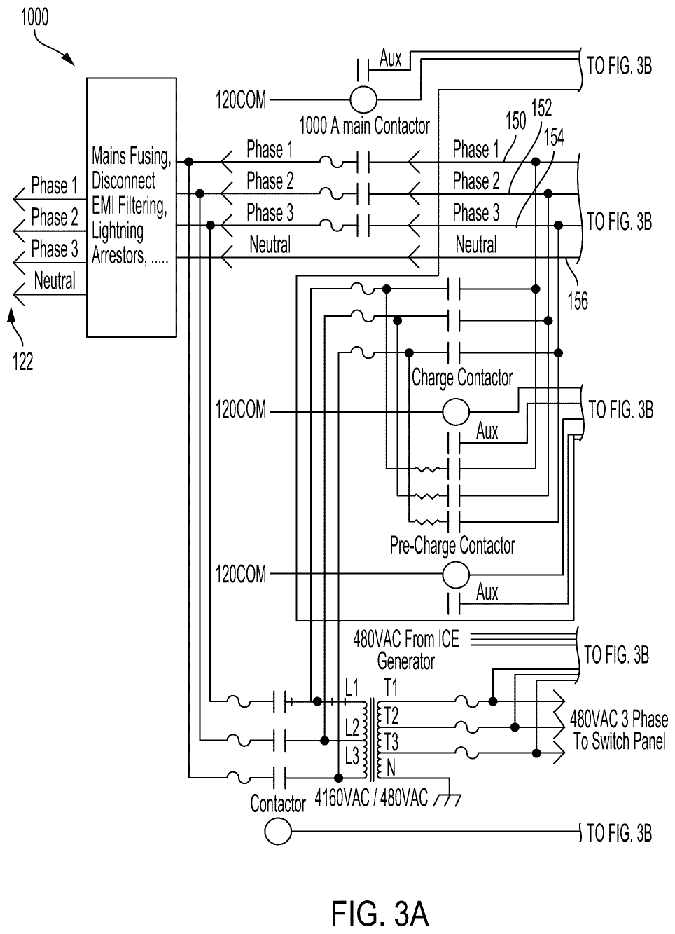

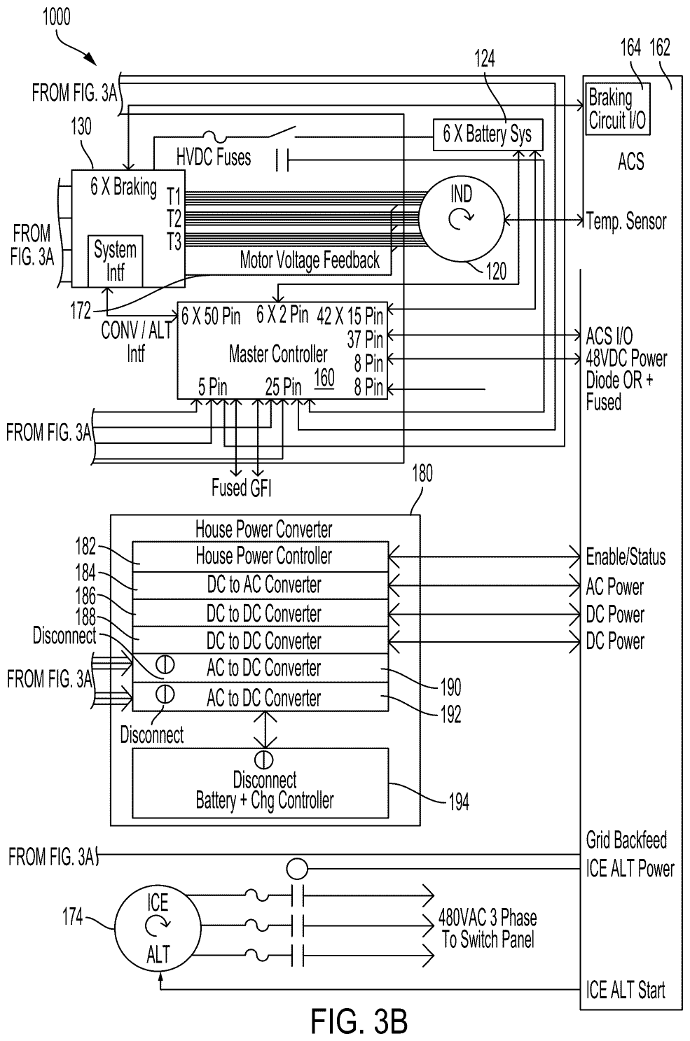

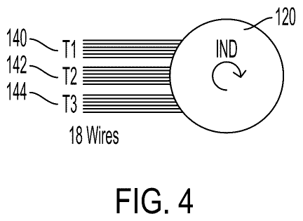

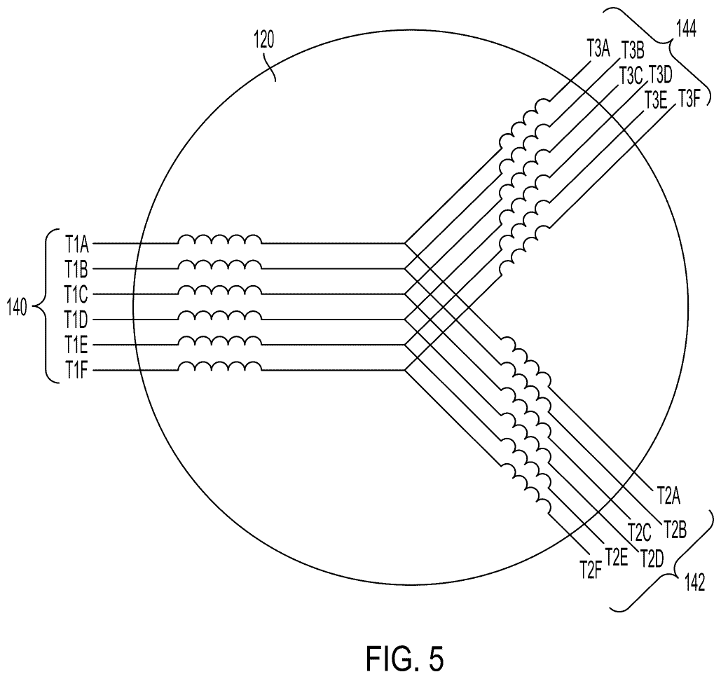

The first converter circuit 102A and the second converter circuit 102B may be coupled to the alternator 120. The first and second converter circuit 102A, 102B may be coupled to the battery system 124. The connections to the alternator 120 are shown in more detail in FIGS. 4 and 5 and the connection to the battery system is shown in more detail in FIG. 3.

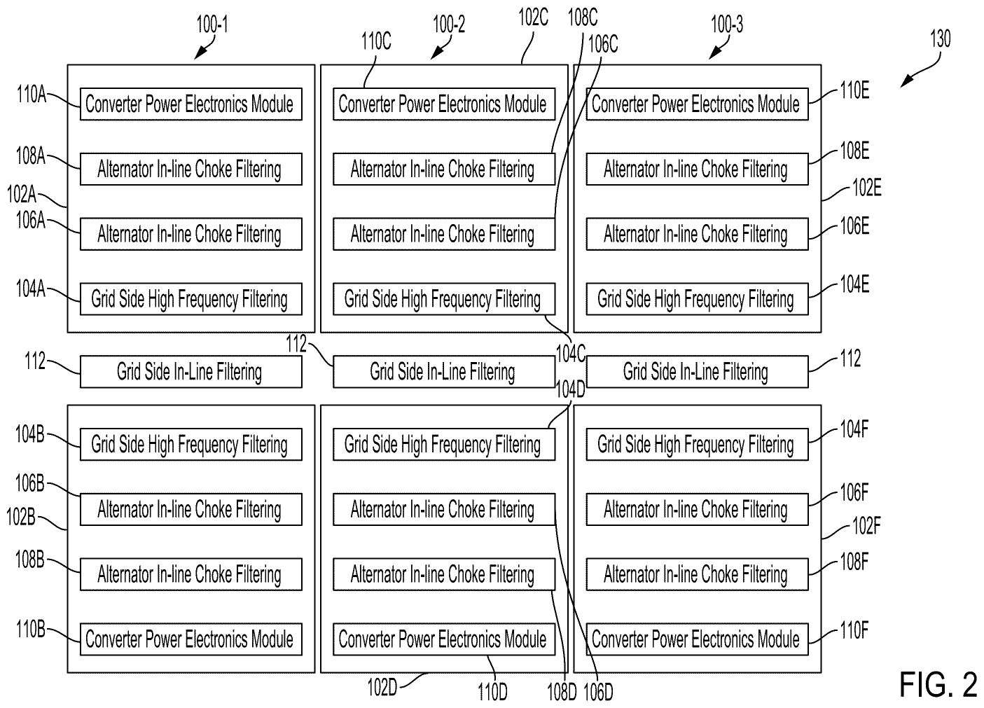

FIG. 2 is a three-phase converter 130 according to an aspect of the present disclosure. The three-phase converter 130 comprises a first circuit 100-1, a second circuit 100-2, and a third circuit 100-3. Each circuit 100-1, 100-2, 100-3 comprises a converter pair, such as the converter pair 100 in FIG. 1. Each of the first 100-1, second 100-2, and third 100-3 circuit may comprise the same elements as the converter pair 100 of FIG. 1.

For example, each converter pair comprises a first converter 102A, 102C, 102E and a second converter 102B, 102D, 102F. Each converter comprises a converter power electronics module 110A, 110B, 110C, 110D, 110E, 110E, 110F, a first alternator in-line filter 108A, 108B, 108C, 108D, 108E, 108F, a second alternator in-line filter 106A, 106B, 106C, 106D, 106E, 106F, and a grid side high frequency filter 104A, 104B, 104C, 104D, 104E, 104F.

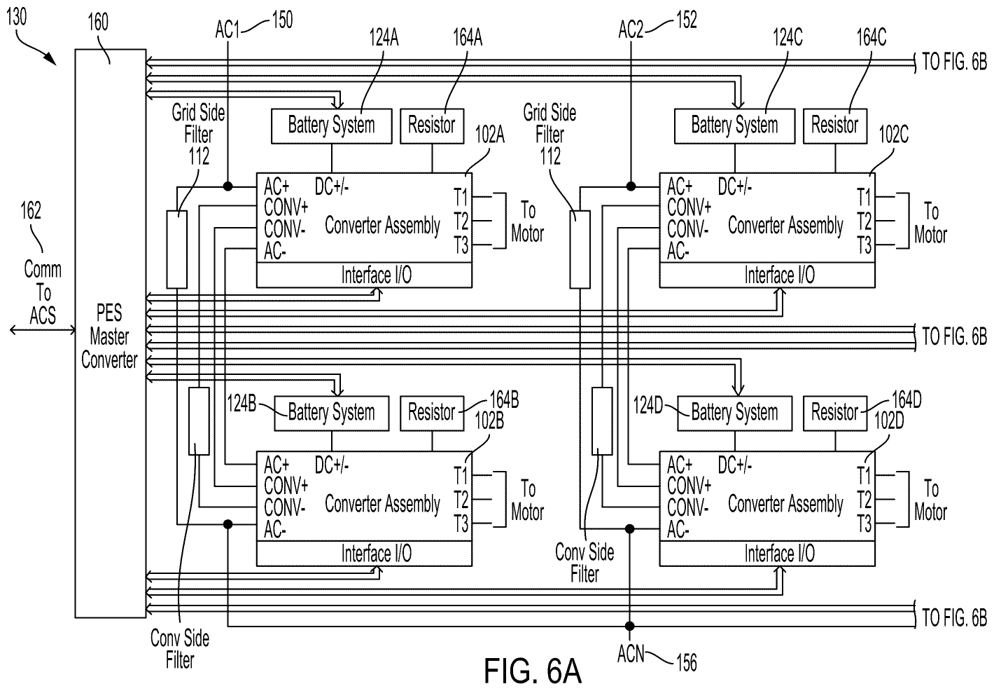

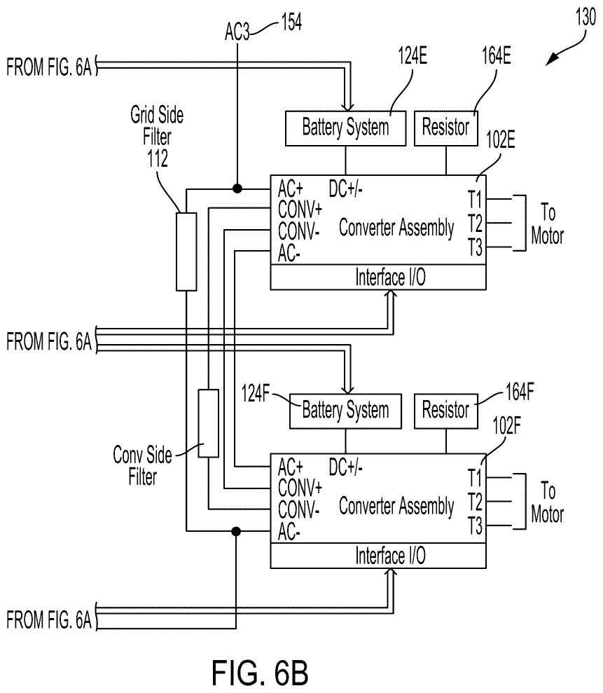

FIG. 3 illustrates a system 1000 to control three-phase power, according to an aspect of the present disclosure. The system 1000 comprises the three-phase converter module 130. The three-phase converter module 130 is shown in detail in FIG. 2 and FIG. 6. The converter module 130 may be coupled to the alternator/motor 120. FIG. 4 illustrates the connection between the motor 120 and the three-phase power converter module 130.

As shown in FIG. 4, between the three-phase converter module 130 and the motor 120 are a first set of windings 140, a second set of windings 142, and a third set of windings 144.

FIG. 5 illustrates a detailed view of the motor 120 windings. The first set of windings 140 to the motor 120 may comprise six conductors. For example, one of each of the six conductors is coupled to one of the six converter circuits 102A, 102B, 102C, 102D, 102E, 102F. For example, the conductor between the motor 120 and the first converter 102A is T1A. The conductor between the motor 120 and the second converter 102B is T1B. The second set of windings 142 comprises six conductors. One of each of the six conductors is coupled to one of the six converter circuits 102A, 102B, 102C, 102D, 102E, 102F. The conductor between the motor 120 and the first converter 102A is T1C. The third set of windings 144 comprises six conductors. One of each of the six conductors is coupled to a one of the six converter circuits 102A, 102B, 102C, 102D, 102E, 102F.

Each of the sets of windings 140, 142, 144 are offset by 120 degrees in phase. For example, the first conductor T1A of the first set of windings 140 is offset by 120 degrees in phase from the first conductor T2A of the second set of windings 142 which is offset by 120 degrees in phase from the first conductor T2C of the third set of windings 144. The first conductor T1A of the first set of windings 140 is offset by 120 degrees in phase from the first conductor T1A of the third set of windings 144.

Turning back to FIG. 3, the system 1000 comprises the three-phase converter module 130. The three-phase converter module 130 is shown in detail in FIG. 6. FIG. 6 is a system level diagram of the converter module 130, according to an aspect of the present disclosure. The converter circuits 102A-102F operate in substantially the same way.

The three-phase converter module 130 may comprise the six converter circuits 102A, 102B, 102C, 102D, 102E, 102F. The six converter circuits 102A, 102B, 102C, 102D, 102E, 102F may form three pairs of converters 100-1, 100-2, 100-3. Each pair of converters 100-1, 100-2, 100-3 may comprise a first converter circuit coupled to a second converter circuit. For example, the first converter pair 100-1 comprises the first converter circuit 102A and the second converter circuit 102B.

Each converter circuit 102A, 102B, 102C, 102D, 102E, 102F has three electrical interfaces, T1, T2, T3. Each of the electrical interfaces is coupled to the motor 120. Each of the converter circuits 102A-102F may be configured to receive a first input voltage at a first amplitude and a first phase, a second input voltage at a second amplitude and a second phase, and a third input voltage at a third amplitude and a third phase from the alternator.

For example, for the first converter circuit 102A, the first input voltage may be received at the first electrical interface T1. The second input voltage may be received at the second electrical interface T2. The third input voltage may be received at the third electrical interface T3.

Each converter circuit 102A-102F may be coupled to a battery system. For example, there may be six battery circuits 124A, 124B, 124C, 124D, 124E, 124F that comprise the battery system. One of each may be coupled to one of each of the converter circuits 102A, 102B, 102C, 102D, 102E, 102F. For example, the first converter circuit 102A may be coupled to the first battery system 124A. Each battery system 124 is configured to support the load follow functionality of the system. The battery system may be configured to compensate for the thermal lag during a power change. The battery system may respond immediately to load changes. For example, the battery system may compensate for thermal lag or load changes at a nuclear power plant and allow the plant to catchup.

The three-phase converter module 130 may comprise a plurality of resistors 16A-164F. The resistors 164A-164F may be braking resistors. The resistors 164A-164F may be part of a braking circuit. The resistors 164A-164F may convert the consumed energy into heat to create a braking effect. The resistors 164A-164F may be used for dynamic braking, such as braking of the motor 120. The braking resistors 164A-164F may be configured stop or slow down the motor 120 by producing a braking torque.

The first converter circuit 102A and the second converter circuit 102B of the first converter pair 100-1 are coupled together by a converter side filter and a grid side filter 104. The grid side filter 104 is coupled between the AC+ conductor of the first converter 102A and the AC− conductor of the second converter 102B. The converter side filter is coupled between the CONV+ conductor of the first converter 102A and the CONV− conductor of the second converter 102B.

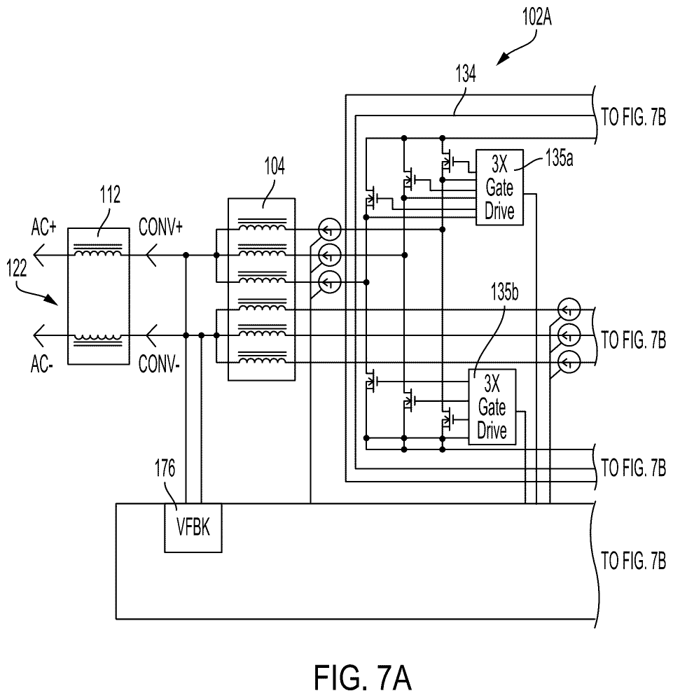

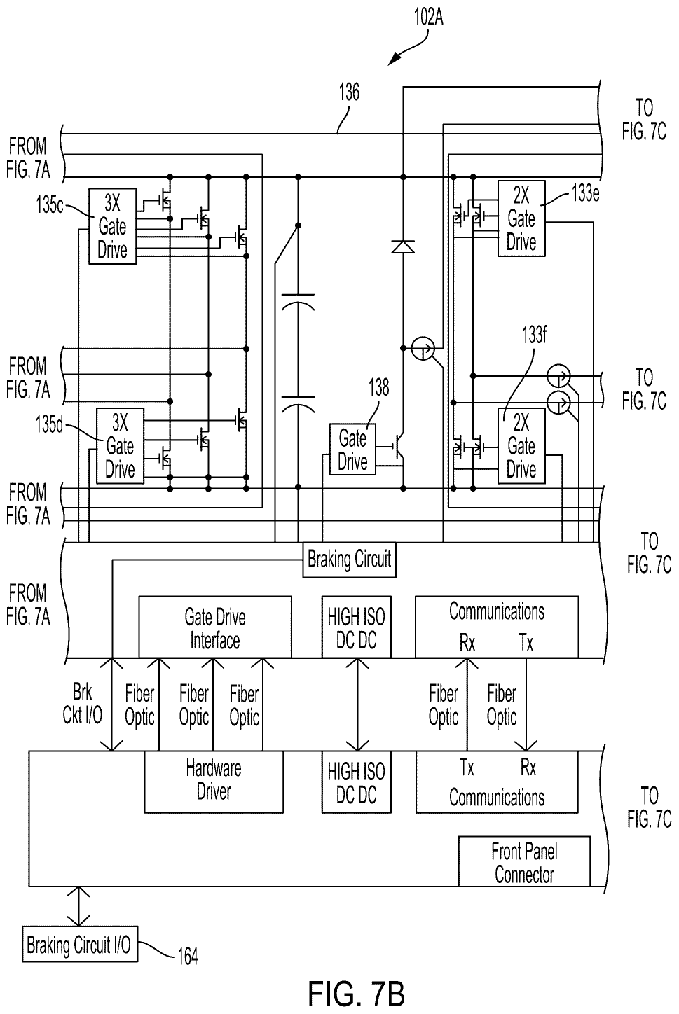

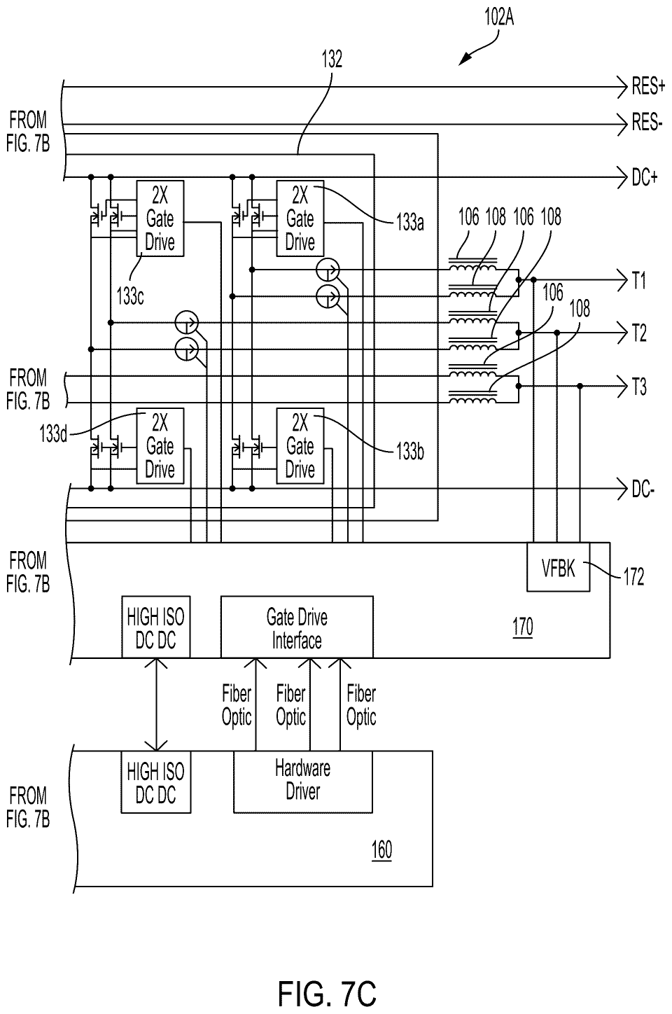

As shown, the converter circuits 102A-102F comprise a plurality of interfaces. Each of the converter circuits 102A-102F has an interface with the motor, T1, T2, T3. Each of the converter circuits 102A-102F may have an AC interface with AC+ and AC− conductors and a converter interface with CONV+ and CONV− conductors. Each of the converter circuits 102A-102F may have a DC+/DC− interface. The interfaces will be described in detail in FIG. 7.

The first 102C, 102E and second 102D, 102E converters of the second 100-2 and third 100-3 converter pairs are formed in a similar manner to the first converter pair 100-1.

Referring now to FIG. 7 in conjunction with FIG. 6, FIG. 7 is a circuit diagram of a converter circuit 102, according to an aspect of this disclosure. The first converter circuit 102A is shown. The converter circuits 102B-102F are substantially the same as the converter circuit 102A. For brevity, only the first converter circuit 102A will be described.

The converter circuit 102A comprises a first conductor T1, a second conductor T2, and a third conductor T3 to the motor. The conductors to the motor 120 are shown in more detail in FIGS. 4 and 5.

A first filter 106 and a second filter 108 may be coupled to each of the windings T1, T2, T3. The first 106 and second 108 filter may be an alternator in line choke filter. The first filter 106 may comprise three inductors in series with the conductors T1-T3. The second filter 108 may comprise three inductors in series with the conductors T1-T3. The inductors of either the first filter 106 and/or the second filter 108 may be iron core inductors. Each conductor T1, T2, T3, may be coupled to a first inductor from the first filter 106 and a second inductor from the second filter 108. There may be six inductors coupled to the three conductors.

The first 106 and second 108 filters may be coupled to a combiner circuit 136. The combiner circuit 136 may comprise an alternator gate drive circuit 132 comprising a plurality of alternator gate drives 133a-133f and a grid driver circuit 134 comprising a plurality of grid gate drives 135a-135d. For example, the plurality of alternator gate drives 132 may comprise six gate drives.

For example, the first conductor T1 is coupled to a first inductor of the first filter 106 and a first inductor of the second filter 108. The first inductor of the first filter 106 is coupled to a first alternator gate drive 133a and a second alternator gate drive 133b. The first inductor of the second filter 108 is coupled to the first alternator gate drive 133a and the second alternator gate drive 133b.

For example, the second conductor T2 is coupled to a second inductor of the first filter 106 and a second inductor of the second filter 108. The second inductor of the first filter 106 is coupled to a third alternator gate drive 133c and a fourth alternator gate drive 133d. The second inductor of the second filter 108 is coupled to the third alternator gate drive 133c and the fourth alternator gate drive 133d.

For example, the third conductor T3 is coupled to a third inductor of the first filter 106 and a third inductor of the second filter 108. The third inductor of the first filter 106 is coupled to a fifth alternator gate drive 133e and a sixth alternator gate drive 133f. The third inductor of the second filter 108 is coupled to the fifth alternator gate drive 133e and the sixth alternator gate drive 133f.

Each of the plurality of alternator gate drives 133a-133f may be coupled to a DC link. The DC link may comprise a positive rail (DC+) and a negative rail (DC−). The DC link may be coupled to all converters 102A, 102B, 102C, 102D, 102E, 102F of the converter module 130.

The DC link may be coupled to the battery system as shown in FIG. 6. The DC link may be internal to each of the converter circuits 102A-102F. The DC link links the grid drive circuit 134 to the alternator drives 132 and serves as the connection point for each of the battery system segments as well as the braking resistors. The battery may be charged via the grid drive circuit 134 or alternator drives 132 through the DC link.

The converter 102A may be coupled to a grid 122 through a first conductor AC+ and a second conductor AC−. The grid 122 may be a power grid comprising transmission lines and distribution centers. The first conductor AC+ and the second conductor AC− may be coupled to the grid side in line filter 112. The grid side in line filter 112 may comprise a first inductor coupled to the AC+ conductor and a second inductor coupled to the AC− conductor. The grid side in line filter 112 may be configured to filter the signal incoming from the grid 122 to the converter pair 100 or filter the outgoing signal from the converter pair 100 to the grid 122.

The grid side inline filter 112 may be coupled to a grid side high frequency filter 104 of the converter circuit 102. The grid side high frequency filter 104 may comprise a plurality of inductors. The grid side high frequency filter 104 may comprise a first set of inductors in parallel coupled to the AC+ conductor and a set of inductors in parallel coupled to the AC− conductor. For example, the first set of inductors may comprise three inductors in parallel coupled to the AC+ conductor. For example, the second set may comprise three inductors in parallel coupled to the AC− conductor.

The combiner circuit 136 may comprise a grid drive circuit 134. The grid driver circuit 134 may comprise four gate drives. The grid driver circuit 134 may be coupled to the DC link. The plurality of grid side drivers of the grid driver circuit 134 may be coupled to the first set of inductors of the grid side filter and/or the second set of inductors of the grid side filter.

For example, the AC+ conductor is coupled to the first set of filters of the grid side filter 104 and to a first gate drive 135a and a second gate drive 135b of the grid drive circuit 134. The first gate drive 135a has a plurality of inputs, each input is coupled to one of the inductors of the first set of filters of the grid side filter 104. The second gate drive 135b has a plurality of inputs, each input is coupled to one of the inductors of the first set of filters of the grid side filter 104. The first 135a and second 135b gate drive are coupled to the DC+ and DC− rails of the DC link. The first 135a and second 135b gate drive are also coupled to the control circuit 110.

For example, the AC− conductor is coupled to the second set of filters of the grid side filter 104 and to a third gate drive 135c and a fourth gate drive 135d of the grid side drive 134. The third gate drive 135c has a plurality of inputs, each input is coupled to one of the inductors of the second set of filters of the grid side filter 104. The fourth gate drive 135d has a plurality of inputs, each input is coupled to one of the inductors of the second set of filters of the grid side filter 104. The third 135c and fourth 135d gate drive are coupled to the DC+ and DC− rails of the DC link. The third 135c and fourth 135d gate drive are also coupled to the control circuit 110.

For example, the converter circuit 102A comprises a braking gate drive 138. The braking resistor 164A of is controlled by a braking gate drive 138. The braking gate drive 138 is coupled to the control circuit 110. The control circuit 110 may be configured to control the braking resistor 164A via the braking gate drive 138.

The control circuit 110 may be coupled to each of the gate drives of the combiner circuit. The control circuit 110 comprises a motor feedback circuit 172 and a grid feedback circuit 176. The motor feedback circuit is coupled to the conductors to the motor T1, T2, T3. The grid feedback circuit 176 is coupled to the grid AC+ and AC−. The control circuit 110 controls the operation of the gate drives of the combiner circuit. The control circuit 110 may control the operation of the gate drives based on the feedback from the motor feedback circuit 172 and/or the grid feedback circuit 176.

The control circuit 110 may be configured to operate in a start-up mode. In start-up mode the control circuit 110 is configured to control the operation of the alternator drives and the grid side drives to convert the incoming alternating current (AC) power from the grid to three phase power to start the motor.

For example, the control circuit may receive a first input voltage at a first amplitude and a first phase, wherein the first input voltage is an alternating current (AC). The control circuit may control the plurality of alternator gate drivers and the plurality of grid gate drivers of the combiner circuit to form the first, second, and third input voltages at the first, second, and third amplitudes and phases based on the first input voltage at the first amplitude and the first phase. The control circuit may output the first, second, and third voltages at the first, second, and third phases to the alternator.

For example, the control circuit combines by controlling the plurality of grid gate drivers of the combiner circuit to convert the first input voltage to a direct current (DC) and controlling the plurality of alternator gate drivers of the combiner circuit to convert the DC to the first, second, and third input voltages at the first, second, and third amplitudes and phases.

The plurality of alternator gate drivers may be configured to invert the DC to the first, second, and third voltages at the first, second, and third phases. The plurality of grid gate drivers may be configured to rectify the DC to a three-phase alternating current (AC).

In some aspects, controlling the plurality of alternator gate drivers and the plurality of grid gate drivers of the combiner circuit includes rectifying, by the grid gate drivers, the AC voltage from the grid to DC, inverting, by the alternator gate drivers, the DC voltage to the first, second, and third voltages at the first, second, and third amplitudes and phases, and outputting, by the alternator gate drivers, the first, second, and third input voltages at the first, second, and third amplitudes and phases.

The three-phase converter may comprise a plurality of filters. The plurality of filters may include the alternator in-line choke filter coupled between the alternator and the alternator gate drivers and the grid side high frequency filter coupled between the grid gate drivers and the grid.

The control circuit 110 is configured to operate in an operational mode. In operational mode the control circuit is configured to control the operation of the alternator drives 132 and the grid side drives 134 to convert the three-phase power from the motor to three phase power for the grid 122.

For example, the control circuit 110 may receive the first, second, and third voltages at the first, second, and third amplitudes and phases from the motor 120. The control circuit may receive the first voltage from the first conductor, the second voltage from the second conductor, and the third voltage from the third conductor.

The control circuit 110 may control the plurality of gate drives to combine the first, second, and third voltages at the first, second, and third amplitudes and phases. The control circuit 110 may output an output voltage at an amplitude and an output phase based on the combination of the first, second, and third voltages.

The control circuit 110 is configured to combine by controlling the plurality of alternator gates drives 132 of the combiner circuit 136 to convert the first, second, and third voltages at the first, second, and third phases to a direct current (DC) and controlling the plurality of grid gate drives 134 of the combiner circuit to convert the DC to the output voltage amplitude at the output phase.

The alternator drives 132 may rectify the first, second, and third voltages at the first, second, and third amplitudes and phases from alternator to a first DC voltage and a second DC voltage; and apply the first DC voltage and the second DC voltage to the high voltage DC link.

The control circuit 110 may control the plurality of gate drives of the combiner circuit 136 by rectifying, by the alternator gate drivers 132, the first, second, and third input voltages at the first, second, and third phases to a direct current (DC) voltage at an amplitude and a phase, inverting, by the grid gate drivers 134, the DC voltage the output from the alternator gate drivers 132 to two phase AC, and outputting, by the grid gate drivers, an AC current to a grid 122.

The converter 100 may comprise a plurality of filters. For example, the plurality of filters may include an alternator in-line choke filter 106, 108 coupled between the alternator and the alternator gate drivers. The plurality of filters may include a grid side high frequency filter 104 coupled between the grid gate drivers 134 and the grid 122.

The control circuit 110 may receive a first input voltage at a first amplitude and a first phase, wherein the first input voltage is an alternating current (AC); control the plurality of alternator gate drivers 132 and the plurality of grid gate drivers 134 of the combiner circuit 136 to form the first, second, and third input voltages at the first, second, and third amplitudes and phases based on the first input voltage at the first amplitude and the first phase, and output the first, second, and third voltages at the first, second, and third phases to the alternator 120.

The converter circuit may be one converter circuit of a pair of converter circuits. The pair of converter circuits are coupled together.

By having the pairs of converters, each single converter is smaller and can double voltage output. The configuration allows for flexibility of deployment for different number of phase loads. Each pair may independently control each phase with the converter pairs. Each pair can independently control a phase of three phase power. Each converter pair may control a phase of power to the grid.

For example, as shown in FIG. 6, the three-phase converter 1000 comprises a first pair of converters 100-1 coupled to an alternator, the second pair of converters 100-2 coupled to the alternator and the third pair of converters 100-3 coupled to the alternator. Each pair of converters is to control a phase of three phase power based on an input voltage at a phase and an amplitude received at each converter of the pairs of converters.

Each of the first pair 100-1, the second pair 100-2, and the third pair 100-3 of converters may include a first converter circuit and a second converter circuit. Each of the first converter circuit and the second converter circuit may comprise a combiner circuit. The combiner circuit may comprise a plurality of alternator gate drivers and a plurality of grid gate drivers.

The three-phase power converter may comprise a DC link coupled to each of the first pair converters, the second pair of converters, and the third pair of converters.

Each converter circuit may comprise a control circuit 110. For example, the first converter circuit 102A comprises a first control circuit 110A.

The control circuits 110A, 110B, 110C, 110D, 110E, 110F of the converter circuits are coupled to a master control circuit 160. The master control circuit 160 is configured to control the control circuits of the converter circuits.

The master control circuit may be configured to control the first, second, and third pair of converters. The master control circuit may control each pair of converters to receive a first input voltage at a first amplitude and a first phase from a conductor of the first set of conductors, receive a second input voltage at a second amplitude and a second phase from a conductor from the second set of conductors, and receive a third input voltage at a third amplitude and a third phase from a conductor from the third set of conductors. The master control circuit may control each pair of converters to convert the first, second, and third voltages at the first, second, and third phases to DC and convert the DC to a phase of three phase AC.

The first and second converter of each of the pairs of converters are configured to receive an input voltage from a grid, wherein the input voltage is an AC voltage, convert, by the plurality of grid gate drivers, the first, second, and third voltages at the first, second, and third phases to DC, convert, by the plurality of alternator gate drivers, the DC to a first voltage at a first amplitude and a first phase, a second voltage at a second amplitude and a second phase, and a third voltage at a third amplitude and a third phase, and output, by the plurality of alternator gate drivers, to the alternator the first, second, and third voltage at the first, second, and third amplitudes and phases.

The system 1000 may include an internal combustion engine 174 to start up the motor when the system is not connected to a grid. The internal combustion engine may start up the motor by providing AC power to the motor. The system may further include a plurality of contactors for startup.

The system includes an access control system 162 coupled to the master control circuit 160 and the house power converter 180. The house power converter 180 to provide power for the control system and baseline power for the components of the system. The house power converter 180 comprises a house power controller to control the components of the house power converter 180. For example, the house power controller may control a DC to AC converter 1824 a plurality of DC-to-DC converters 186, 188, and a plurality of AC to DC converters 190, 192.

The AC to DC converters may couple to the internal combustion engine 174 for startup. The AC to DC converter may couple to the grid and receive three phase power to charge the battery 194.

The house power converter 180 may comprise a battery 194 and charge controller to power the components of the three-phase converter 1000.

The three-phase power converter 1000 may operate in grid following mode. The three-phase power converter 1000 may operate in grid forming to provide voltage and frequency support to the grid, e.g., during disturbances or outages.

The converter pair 100 is configured to receive from the alternator a first input voltage at a first amplitude and a first phase, a second input voltage at a second amplitude and a second phase, and a third input voltage at a third amplitude and a third phase. The converter pair is configured to convert the three voltages into three phase power. The converter pair may be configured to convert the three voltages into a singular phase of three phase power. The converter pair may be configured to convert the three voltages into two phase power on a DC+ conductor and a DC− conductor.

The converter pair 100 may be configured to receive a first input voltage at a first amplitude and a first phase and a second input voltage at a second amplitude and a second phase from the grid. The converter pair may be configured to convert the two-phase power to three phase power.

The three-phase power converter 1000 may be configured to receive at each converter of each converter pair a first input voltage at a first amplitude and a first phase, a second input voltage at a second amplitude and a second phase, and a third input voltage at a third amplitude and a third phase. Each of the converter pairs may be configured to transform the three input voltages into a single phase of three phase power.

The three-phase power converter 1000 may be configured to receive at each converter of each converter pair, from the grid, a first input AC voltage. Each of the converter pairs may be configured to transform the input voltage into three phase power.

In one example, the eVinci™ Microreactor design uses an open-air Brayton cycle to turn an alternator that generates electrical power for loads. The output of the alternator is high frequency, high voltage AC that varies over the operating range of the micro-reactor and is unsuitable to supply customer loads directly. The PES converts the high frequency AC voltage to DC voltage then converts it to 4160VAC, 3 phase, 60 Hz power that can be supplied to a microgrid.

Having thus described several aspects and embodiments of the technology of this application, it is to be appreciated that various alterations, modifications, and improvements will readily occur to those of ordinary skill in the art. Such alterations, modifications, and improvements are intended to be within the scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

In most embodiments, a processor may be a physical or virtual processor. In other embodiments, a virtual processor may be spread across one or more portions of one or more physical processors. In certain embodiments, one or more of the embodiments described herein may be embodied in hardware such as a Digital Signal Processor (DSP). In certain embodiments, one or more of the embodiments herein may be executed on a DSP. One or more of the embodiments herein may be programmed into a DSP. In some embodiments, a DSP may have one or more processors and one or more memories. In certain embodiments, a DSP may have one or more computer readable storages. In many embodiments, a DSP may be a custom designed ASIC chip. In other embodiments, one or more of the embodiments stored on a computer readable medium may be loaded into a processor and executed.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112(f). Absent a recital of “means for” in the claims, such claims should not be construed under 35 USC 112. Limitations from the specification are not intended to be read into any claims, unless such limitations are expressly included in the claims.

Embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a computer program product embodied in one or more computer readable medium(s) having computer readable program code embodied thereon.

What is claimed is:

1. A three-phase power converter, the three-phase power converter comprising:
a converter circuit coupleable to an alternator, the converter circuit to couple to the alternator:
a first voltage at a first amplitude and a first phase;
a second voltage at a second amplitude and a second phase; and
a third voltage at a third amplitude and a third phase;
the converter circuit comprising a combiner circuit, the combiner circuit comprising:
a plurality of alternator gate drivers; and
a plurality of grid gate drivers;
a high voltage DC link coupled to the plurality of alternator gate drivers and the plurality of grid gate drivers; and
a control circuit to:
receive the first, second, and third voltages at the first, second, and third amplitudes and phases from the alternator;
control the plurality of alternator gate drivers and the plurality of grid gate drivers to combine the first, second, and third voltages at the first, second, and third amplitudes and phases; and
output an output voltage at an amplitude and a phase based on the combination of the first, second, and third voltages.

2. The three-phase power converter of claim 1, wherein combine comprises:
control the plurality of alternator gates drivers of the combiner circuit to convert the first, second, and third voltages at the first, second, and third phases to a direct current (DC) voltage; and
control the plurality of grid gate drivers of the combiner circuit to convert the DC voltage to the output voltage at the amplitude and the phase.

3. The three-phase power converter of claim 2, wherein the plurality of alternator gate drivers are configured to:
rectify the first, second, and third voltages at the first, second, and third amplitudes and phases from alternator to a first DC voltage and a second DC voltage; and
apply the first DC voltage and the second DC voltage to the high voltage DC link.

4. The three-phase power converter of claim 1, wherein controlling plurality of alternator gate drivers and the plurality of grid gate drivers of the combiner circuit comprises:
rectifying, by the plurality of alternator gate drivers, the first, second, and third voltages at the first, second, and third amplitudes and phases to a direct current (DC) voltage at an amplitude and a phase;
inverting, by the plurality of grid gate drivers, the DC voltage from the alternator gate drivers to a two-phase AC voltage; and
outputting, by the grid gate drivers, the AC voltage to a grid.

5. The three-phase power converter of claim 1, further comprising a plurality of filters, wherein the plurality of filters comprises:
an alternator in-line choke filter coupled between the alternator and the alternator gate drivers; and
a grid side high frequency filter coupled between the grid gate drivers and a grid.

6. The three-phase power converter of claim 1, wherein the control circuit is configured to:
receive a first input voltage at a first amplitude and a first phase, wherein the first input voltage is an alternating current (AC) voltage;
control the plurality of alternator gate drivers and the plurality of grid gate drivers of the combiner circuit to form the first, second, and third voltages at the first, second, and third amplitudes and phases based on the first input voltage at the first amplitude and the first phase; and
output the first, second, and third voltages at the first, second, and third phases to the alternator.

7. The three-phase power converter of claim 6, wherein controlling the plurality of alternator gate drivers and the plurality of grid gate drivers of the combiner circuit comprises:
rectifying, by the grid gate drivers, the AC voltage to a direct current (DC) voltage;
inverting, by the alternator gate drivers, the DC voltage to the first, second, and third voltages at the first, second, and third amplitudes and phases; and
outputting, by the alternator gate drivers, the first, second, and third voltages at the first, second, and third amplitudes and phases to the alternator.

8. A three-phase power converter, the three-phase power converter comprising:
a converter circuit coupleable to an alternator, the converter circuit to couple to the alternator:
a first voltage at a first amplitude and a first phase;
a second voltage at a second amplitude and a second phase; and
a third voltage at a third amplitude and a third phase;
the converter circuit comprising a combiner circuit, the combiner circuit comprising:
a plurality of alternator gate drivers; and
a plurality of grid gate drivers;
a high voltage DC link coupled to the plurality of alternator gate drivers and the plurality of grid gate drivers; and
a control circuit to:
receive a first input voltage at a first amplitude and a first phase, wherein the first input voltage is an alternating current (AC) voltage;
control the plurality of alternator gate drivers and the plurality of grid gate drivers of the combiner circuit to form the first, second, and third voltages at the first, second, and third amplitudes and phases based on the first input voltage at the first amplitude and the first phase; and
output the first, second, and third voltages at the first, second, and third phases to the alternator.

9. The three-phase power converter of claim 8, wherein combine comprises:
control the plurality of grid gate drivers of the combiner circuit to convert the first input voltage to a direct current (DC); and
control the plurality of alternator gate drivers of the combiner circuit to convert the DC to the first, second, and third voltages at the first, second, and third amplitudes and phases.

10. The three-phase power converter of claim 9, wherein the plurality of alternator gate drivers are configured to invert the DC to the first, second, and third voltages at the first, second, and third amplitudes and phases; and
wherein the plurality of grid gate drivers are configured to rectify the DC to a three-phase alternating current (AC).

11. The three-phase power converter of claim 8, wherein controlling the plurality of alternator gate drivers and the plurality of grid gate drivers of the combiner circuit comprises:
rectifying, by the grid gate drivers, the AC voltage to a direct current (DC) voltage;
inverting, by the alternator gate drivers, the DC voltage to the first, second, and third voltages at the first, second, and third amplitudes and phases; and
outputting, by the alternator gate drivers, the first, second, and third voltages at the first, second, and third amplitudes and phases to the alternator.

12. The three-phase power converter of claim 8, further comprising a plurality of filters, wherein the plurality of filters comprises:
an alternator in-line choke filter coupled between the alternator and the alternator gate drivers; and
a grid side high frequency filter coupled to the grid gate drivers.

13. A three-phase power converter, the three-phase power converter comprising:
a first pair of converters coupled to an alternator;
a second pair of converters coupled to the alternator; and
a third pair of converters coupled to the alternator;
wherein each pair of converters is to control a phase of three phase power based on an input voltage at a phase and an amplitude received at each converter of the pairs of converters.

14. The three-phase power converter of claim 13, wherein each of the first pair, the second pair, and the third pair of converters comprise a first converter circuit and a second converter circuit.

15. The three-phase power converter of claim 14, wherein each of the first converter circuit and the second converter circuit comprise:
a converter circuit coupleable to the alternator, the converter circuit to couple to the alternator:
a first voltage at a first amplitude and a first phase;
a second voltage at a second amplitude and a second phase; and
a third voltage at a third amplitude and a third phase;
a combiner circuit comprising:
a plurality of alternator gate drivers; and
a plurality of grid gate drivers; and
a control circuit to control the plurality of alternator gate drivers and the plurality of grid gate drivers.

16. The three-phase power converter of claim 15, further comprising a DC link coupled to each of the first pair of converters, the second pair of converters, and the third pair of converters.

17. The three-phase power converter of claim 16, comprising a master control circuit configured to control each of the control circuits for each of the first and second converters.

18. The three-phase power converter of claim 17, further comprising the alternator comprising a first set of windings, a second set of windings, and a third set of windings.

19. The three-phase power converter of claim 18, wherein the master control circuit is configured to control the first, second, and third pair of converters to each:
receive a first input voltage at a first amplitude and a first phase from a conductor of the first set of windings;
receive a second input voltage at a second amplitude and a second phase from a conductor from the second set of windings;
receive a third input voltage at a third amplitude and a third phase from a conductor from the third set of windings;
convert the first, second, and third voltages at the first, second, and third phases to DC; and
convert the DC to a phase of three phase AC.

20. The three-phase power converter of claim 18, wherein the first and second converter of each of the pairs of converters are configured to:
receive an input voltage from a grid, wherein the input voltage is an AC voltage;
convert, by the plurality of grid gate drivers, the first, second, and third voltages at the first, second, and third phases to DC;
convert, by the plurality of alternator gate drivers, the DC to a first voltage at a first amplitude and a first phase, a second voltage at a second amplitude and a second phase, and a third voltage at a third amplitude and a third phase; and
output, by the plurality of alternator gate drivers, to the alternator the first, second, and third voltage at the first, second, and third amplitudes and phases.
